(19) United States
(12) Patent Application Publication
(10) Pub. No.: US 2025/0218606 A1
(43) Pub. Date: Jul. 3, 2025

(54) PLASMA FOCUS SYSTEMS AND METHODS FOR ANEUTRONIC FUSION

(71) Applicant: FUSE ENERGY TECHNOLOGIES CORP., San Leandro, CA (US)

(72) Inventors: Sing Lee, Chadstone, Victoria (AU); Vahid Damideh, Napierville, Quebec (CA); Jean-Christoph Btaiche, Napierville, Quebec (CA)

(73) Assignee: FUSE ENERGY TECHNOLOGIES CORP., San Leandro, CA (US)

(21) Appl. No.: 18/850,538

(22) PCT Filed: Mar. 24, 2023
(86) PCT No.: PCT/US2023/016273

§ 371 Date: Sep. 24, 2024

Related U.S. Application Data
(60) Provisional application No. 63/323,697, filed on Mar. 25, 2022.

(51) Int. Cl. G21B 1/05; G21B 1/21

(52) U.S. Cl. CPC G21B 1/05; G21B 1/21

(57) ABSTRACT

A plasma focus system for aneutronic fusion is disclosed that includes an electrode assembly having an inner electrode extending along a pinch axis from a discharge end to a focus end, and an outer electrode surrounding the inner electrode to define a plasma channel for receiving a process gas containing aneutronic fusion fuel. The system also includes a power supply unit for applying a discharge driving signal to the electrodes, which causes the gas to be ionized into a plasma current sheath at the discharge end that flows along the plasma channel to reach the focus end where the sheath collapses toward the pinch axis to form a plasma pinch. The inner electrode has a tapered tip at the focus end that is configured to increase a speed of the sheath sufficiently to reach a pinch temperature high enough for the fuel to undergo aneutronic fusion reactions within the pinch.

### RELATED PATENT APPLICATION

The present application claims priority to U.S. Provisional Patent Application No. 63/323,697 filed on Mar. 25, 2022, the disclosure of which is incorporated herein by reference in its entirety.

### TECHNICAL FIELD

The technical field generally relates to plasma technologies and, more particularly, to plasma focus systems and methods.

### BACKGROUND

Dense plasma focus systems (or simply plasma focus systems) are pinch-based plasma generation systems in which a high pulsed voltage is applied between two coaxial electrodes disposed inside a vacuum chamber filled with a process or working gas. The coaxial electrodes extend from a closed end to an open end, with an electrical insulator disposed between the electrodes at the closed end. The application of the voltage leads to the ionization and breakdown of the gas on the insulator, and the formation of a plasma shockwave-current-sheath layer, hereinafter referred to as a plasma current sheath for simplicity. Under the effect of the Lorentz force created by the radial current flowing in the plasma and the current-induced azimuthal magnetic field, the current sheath is driven axially along the electrodes toward the open end. Upon reaching the open end, the current sheath is radially compressed onto the axis to form a hot and dense pinch plasma column. During the pinch phase, plasma instabilities can lead to the emission of electron and ion beams, electromagnetic radiation pulses (e.g., X-rays), and, if the working gas contains neutronic fusion fuel, neutrons. In fusion power applications, the kinetic energy of the fusion neutrons is converted into thermal energy, which is subsequently converted into electricity. Problems and limitations associated with neutronic fusion include structural radiation damage, radioactive waste produced by neutron activation, indirect conversion of fusion energy into electricity, and the requirements for biological shielding. It is envisioned that aneutronic fusion could help mitigate these problems and limitations.

### SUMMARY

The present description generally relates to plasma focus systems and methods for producing aneutronic fusion.

In accordance with an aspect, there is provided a plasma focus system for aneutronic fusion, the plasma focus system including:
an electrode assembly including:
   an inner electrode extending along a pinch axis between a discharge end and a focus end, the inner electrode terminating in a tapered tip at the focus end; and
   an outer electrode surrounding the inner electrode and defining therebetween a plasma channel configured to receive a process gas including aneutronic fusion fuel; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch, and wherein the tapered tip is configured to increase a speed of the plasma current sheath flowing therealong sufficiently for the plasma pinch to reach a pinch temperature at which the aneutronic fusion fuel undergoes aneutronic fusion reactions within the plasma pinch.

In some embodiments, the tapered tip tapers from a first radius, at a taper start point located between the discharge end and the focus end, to a second radius, at the focus end, wherein a ratio of the first radius to the second radius is greater than twenty. In some embodiments, the ratio of the first radius to the second radius ranges between from about twenty to about one hundred.

In some embodiments, the first radius ranges from about 2 cm to about 40 cm and the second radius ranges from about 1 mm to about 20 mm. In some embodiments, the tapered tip tapers from the first radius to the second radius at a tapering angle ranging from about 40° to about 85°, wherein the tapering angle is defined with respect to a direction parallel to the pinch axis. In some embodiments, the tapered tip tapers linearly from the first radius to the second radius. In other embodiments, the tapered tip tapers nonlinearly from the first radius to the second radius.

In some embodiments, the tapered tip has a longitudinal extent ranging from about 1 cm to about 10 cm. In some embodiments, a ratio of the longitudinal extent of the tapered tip to a longitudinal extent of the inner electrode ranges from about 0.05 to about 0.7.

In some embodiments, a ratio of a longitudinal extent of the inner electrode to a diameter of the inner electrode at the discharge end is greater than one. In other embodiments, a ratio of a longitudinal extent of the inner electrode to a diameter of the inner electrode at the discharge end is equal to or less than one.

In some embodiments, the tapered tip has a hollow interior configured to allow the plasma pinch to extend at least partially thereinside.

In some embodiments, the power supply unit includes a pulsed-DC power supply including a capacitor bank and a switch.

In some embodiments, the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, the power supply unit is configured to apply the discharge driving signal once every one minute to sixty minutes, corresponding to a single-shot operation mode. In some embodiments, the power supply unit is configured to apply the discharge driving signal once every ten milliseconds to ten seconds, corresponding to a repetitive-shot operation mode.

In some embodiments, the power supply unit is configured to apply the discharge driving signal based on the configuration of the tapered tip to control the speed of the plasma current sheath to reach a maximum sheath speed value ranging from about 100 cm/μs to about 1,000 cm/μs as the plasma current sheath collapses toward the pinch axis to form the plasma pinch. Such maximum sheath speed values are higher than the maximum speed values of plasma current sheaths in the radial phase of non-tapered arrangements, which can range from about 14 cm/μs to about 30 cm/μs. In some embodiments, the plasma focus system is configured to increase a maximum speed of the plasma current sheath by a speed-enhancement factor ranging from about eight to about fifty compared to conventional plasma focus systems provided with non-tapered inner electrodes.

In some embodiments, the power supply unit is configured to apply the discharge driving signal based on the configuration of the tapered tip to form the plasma pinch with a pinch temperature ranging from about 30 keV to about 500 keV.

In some embodiments, the power supply unit is configured to apply the discharge driving signal to control the speed of the plasma current sheath prior to the tapered tip to remain below a threshold sheath speed value at which the plasma current sheath undergoes mass-field-force-field separation. In some embodiments, the threshold sheath speed value is about 10 cm/μs.

In some embodiments, the electrode assembly includes an electrical insulator interposed between the inner electrode and the outer electrode at the discharge end.

In some embodiments, the plasma focus system includes a vacuum chamber housing at least part of the electrode assembly and configured to contain the process gas therein. In some embodiments, the outer electrode forms part of the vacuum chamber.

In some embodiments, the plasma focus system includes a process gas supply unit configured to supply the process gas inside the plasma channel. In some embodiments, the vacuum chamber can include at least one gas inlet port configured for connection to the process gas supply unit to allow the process gas to be introduced inside the vacuum chamber, and thus inside the plasma channel.

In some embodiments, the aneutronic fusion fuel includes the aneutronic fusion fuel includes decaborane B₁₀H₁₄ (for the p-¹¹B reaction), or deuterium-helium-3 (for the D-³He reaction), or helium-3 (for the ³He-³He reaction), or lithium hydride (for the p-⁶Li reaction or the p-⁷Li reaction), or lithium deuteride (for the D-⁶Li reaction), or any other practical aneutronic fusion fuel, or any combination thereof. In some embodiments, the process gas is filled or created with the help of a discharge or laser irradiation inside the vacuum chamber with a fill pressure equivalent which ranges from about 1 Torr to about 100 Torr. For example, decaborane, lithium hydride, and lithium deuteride are solid at room temperature and can be sublimated into gaseous form by an electric discharge or pulsed laser irradiation prior to the main discharge.

In some embodiments, the plasma focus system includes a direct energy conversion unit configured to extract energy from reaction products of the aneutronic fusion reactions and convert the extracted energy into electricity.

In some embodiments, a fill pressure of the process gas inside the plasma channel ranges from about 1 Torr to about 100 Torr.

In some embodiments, the inner electrode is configured as an anode and the outer electrode is configured as a cathode, in that the inner electrode is positively biased with respect to the outer electrode. In other embodiments, the polarity of the inner and outer electrodes is reversed.

In accordance with another aspect, there is provided a plasma focus method of aneutronic fusion, including:
providing a plasma focus system including an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
supplying a process gas including aneutronic fusion fuel inside the plasma channel; and
applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch,
wherein the tapered tip is configured to increase a speed of the plasma current sheath flowing therealong sufficiently for the plasma pinch to reach a pinch temperature high enough for the aneutronic fusion fuel to undergo aneutronic fusion reactions within the plasma pinch.

In some embodiments, providing the plasma focus system includes configuring the tapered tip to taper from a first radius, at a taper start point located between the discharge end and the focus end, to a second radius, at the focus end, wherein a ratio of the first radius to the second radius ranges from about twenty to about one hundred. In some embodiments, the first radius ranges from about 2 cm to about 40 cm and the second radius ranges from about 1 mm to about 20 mm. In some embodiments, configuring the tapered tip includes providing the tapered tip with a tapering angle ranging from about 400 to about 85°, wherein the tapering angle is defined with respect to a direction parallel to the pinch axis.

In some embodiments, configuring the tapered tip includes providing the tapered tip with a longitudinal extent ranging from about 1 cm to about 10 cm.

In some embodiments, applying the discharge driving signal includes applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, applying the discharge driving signal includes applying the discharge driving signal once every one minute to sixty minutes, corresponding to a single-shot operation mode. In some embodiments, applying the discharge driving signal includes applying the discharge driving signal once every ten milliseconds to ten seconds, corresponding to a repetitive-shot operation mode.

In some embodiments, applying the discharge driving signal includes controlling the discharge driving signal based on the configuration of the tapered tip to control the speed of the plasma current sheath to reach a maximum sheath speed value ranging from about 100 cm/μs to about 1,000 cm/μs as the plasma current sheath collapses toward the pinch axis to form the plasma pinch.

In some embodiments, applying the discharge driving signal includes controlling the discharge driving signal based on the configuration of the tapered tip to form the plasma pinch with a pinch temperature ranging from about 30 keV to about 500 keV.

In some embodiments, applying the discharge driving signal includes controlling the discharge driving signal to control the speed of the plasma current sheath prior to the tapered tip to remain below a threshold sheath speed value at which the plasma current sheath undergoes mass-field-force-field separation. In some embodiments, the threshold sheath speed value is about 10 cm/μs.

In some embodiments, providing the plasma focus system includes enclosing at least part of the electrode assembly in a vacuum chamber configured to contain the process gas therein.

In some embodiments, the aneutronic fusion fuel includes decaborane B₁₀H₁₄, for the p-¹¹B reaction; or deuterium-helium-3, for the D-³He reaction; or helium-3, for the ³He-³He reaction; or lithium hydride, for the p-⁶Li reaction or the p-⁷Li reaction; or lithium deuteride for the D-⁶Li reaction; or any combination thereof.

In some embodiments, the method further includes extracting energy from reaction products of the aneutronic fusion reactions, and converting the extracted energy into electricity

In accordance with another aspect, there is provided a plasma focus system for aneutronic fusion, the plasma focus system including:
an inner electrode extending along a pinch axis between a discharge end and a focus end; and
an outer electrode surrounding the inner electrode with an interelectrode gap therebetween defining an annular plasma channel configured to contain a process gas including aneutronic fusion fuel,
wherein applying a discharge driving signal to the inner electrode and the outer electrode causes the process gas to be ionized into a plasma current sheath at the discharge end and the plasma current sheath to flow along the plasma channel and reach the focus end where the plasma current sheath radially collapses toward the pinch axis to form a plasma pinch, and
wherein the inner electrode terminates in a tapered tip at the focus end, the tapered tip being configured to increase a speed of the plasma current sheath flowing therealong sufficiently for the plasma pinch to reach a pinch temperature high enough for the aneutronic fusion fuel to undergo aneutronic fusion reactions within the plasma pinch.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIG. 1 is a schematic longitudinal cross-sectional view of a plasma focus system, in accordance with an embodiment.

FIG. 2 is a schematic longitudinal cross-sectional view of a plasma focus system, in accordance with another embodiment.

FIG. 3 is a schematic longitudinal cross-sectional view of a plasma focus system, in accordance with another embodiment.

FIG. 4 is a schematic longitudinal cross-sectional view of a plasma focus system, in accordance with another embodiment.

FIG. 5 is a schematic longitudinal cross-sectional view of a plasma focus system, in accordance with another embodiment.

FIG. 6 is a schematic front elevation cross-sectional view of a plasma focus system, in accordance with another embodiment.

FIG. 7 is a schematic longitudinal cross-sectional view of a plasma focus system, in accordance with another embodiment.

FIG. 8 is a schematic longitudinal cross-sectional view of a plasma focus system, in accordance with another embodiment.

FIG. 9 is a flow diagram of a plasma focus method of aneutronic fusion, in accordance with an embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of 10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to plasma focus systems and methods for producing aneutronic fusion reactions. The techniques disclosed herein may be used in various fields and applications that use aneutronic energetic fusion reactions, including, to name a few, fusion power applications, direct conversion of charged particle energy to electricity, direct conversion of X-rays to electricity, and aneutronic fusion engine.

Nuclear fusion energy is energy produced by a nuclear fusion process in which at least two or more lighter atomic nuclei are joined to form a heavier nucleus whose mass is less than the sum of the masses of the lighter nuclei. The difference in mass is released as energy, which can be harnessed to produce electricity. Fusion reactions can be neutronic or aneutronic depending on whether the fusion reaction products include neutrons or not, in addition to charged nuclei. Non-limiting examples of neutronic fusion reactions include the deuterium-deuterium (D-D) reaction and the deuterium-tritium (D-T) reaction, which generates neutrons at 2.45 MeV and 14.1 MeV, respectively. Most fusion energy research is currently based on neutronic fusion, notably the D-T reaction due to its low ignition temperature and high reactivity compared to other fusion fuels. However, as noted above, neutronic fusion presents a number of challenges and issues, which include structural radiation damage, radioactive waste produced by neutron activation, indirect conversion of fusion energy into electricity, and the requirements for biological shielding. By contrast, in aneutronic fusion, no or negligible amounts of neutrons are produced, thus avoiding or mitigating the adverse effects associated with neutron radiation. Furthermore, because fusion energy is released mostly in the form of charged particles, aneutronic fusion could allow for the direct energy conversion to electricity. Non-limiting examples of aneutronic fusion reactions include the proton-boron-11 (p-¹¹B) reaction, the deuterium-helium-3 (D-³He) reaction, the helium-3-helium-3 (³He-³He) reaction, the proton-lithium-6 (p-⁶Li) reaction, the proton-lithium-7 (p-⁷Li) reaction, and the deuterium-lithium-6 (D-⁶Li) reaction. The p-¹¹B reaction is often considered as the most promising for aneutronic fusion. One challenge with aneutronic fusion is that it involves peak reactivities that are lower and that occur at higher temperatures compared to the D-T reaction, making it more difficult to reach ignition conditions.

It has been observed that a wide range of conventional neutron-optimized plasma focus systems operate with a speed factor (or drive parameter)

$$S = ( I / a ) {p}^{- 1 / 2}$$

having a near-constant value of

$$89 \pm 8 kA \cdot {cm}^{- 1} \cdot {Torr}^{- 1 / 2} ,$$

where I is the peak drive current, a is the anode radius, and p is the fill gas pressure [1]. This near-constant value of S is consistent with a narrow range of peak axial speeds around 10 cm/μs and peak radial speeds around 20-30 cm/μs. These speed values lead to pinch temperatures ranging from about 0.1 keV to about 1 keV. At such pinch temperatures, the thermonuclear reactivities of several relevant aneutronic fusion reactions are very far below significant levels, which would be reached at pinch temperatures of the order of at least 30 keV. Such pinch temperatures represent an increase of about 100 times compared to pinch temperatures values observed in conventional plasma focus systems. As pinch temperature scales about quadratically with plasma speed, such an increase in pinch temperature could, in principle, be achieved by increasing the peak plasma speeds of conventional plasma focus systems by a factor of the order of 100^{1/2}=10, that is, from about 10 cm/μs to about 100 cm/μs for the peak axial speed and from about 20-30 cm/μs to about 200-300 cm/μs for the peak radial speed. However, conventional plasma focus systems tend to not operate well above certain speeds. It was found that increasing the peak axial speed above 10 cm/μs can lead to a separation between the mass-field and the force-field in the magnetic field structure of the plasma. This separation causes the mass-field to reach the end of the axial acceleration phase and enter the radial collapse phase while the driving force-field is still in the axial phase. In this situation the force-field is pushing in the axial direction while the mass-field is already flowing in the radial direction. This angular disparity between the pushing force-field and the mass-field can result in a pinch characterized by poor compression and low fusion yield.

The present techniques aim to provide plasma focus systems and methods in which the pinch temperature can be increased sufficiently for aneutronic fusion conditions to be achievable within the pinch, but in which the angular disparity mentioned above, due to mass-field-force-field separation, can be avoided or at least mitigated. As described in greater detail below, this can be achieved at least in part by the provision of a tapered tip at the focus end of the inner electrode of the plasma focus system.

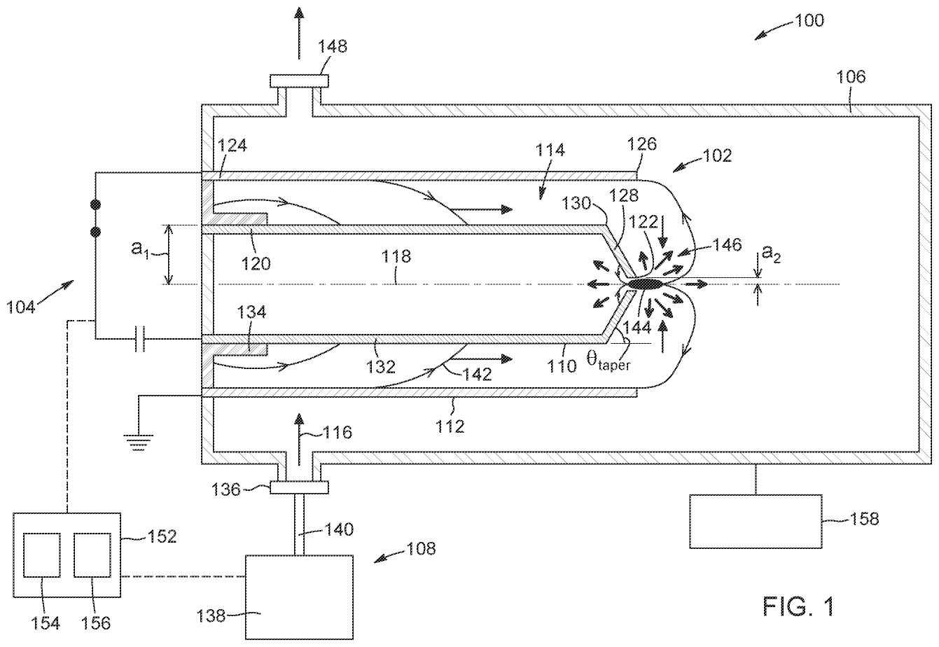

Referring to FIG. 1, there is illustrated a schematic longitudinal cross-sectional view of an embodiment of a plasma focus system 100 used for aneutronic fusion. The plasma focus system 100 of FIG. 1 generally includes an electrode assembly 102, a power supply unit 104, a vacuum chamber 106, and a process gas supply unit 108. More details regarding the structure, configuration, and operation of these components and other possible components of the plasma focus system 100 are provided below. It is appreciated that FIG. 1 is a simplified schematic representation that illustrates certain features and components of the plasma focus system 100, such that additional features and components that may be useful or necessary for its practical operation may not be specifically depicted. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices (e.g., chillers for electrodes), operation monitoring and diagnostic devices (e.g., sensors), processors and controllers, and other types of hardware and equipment.

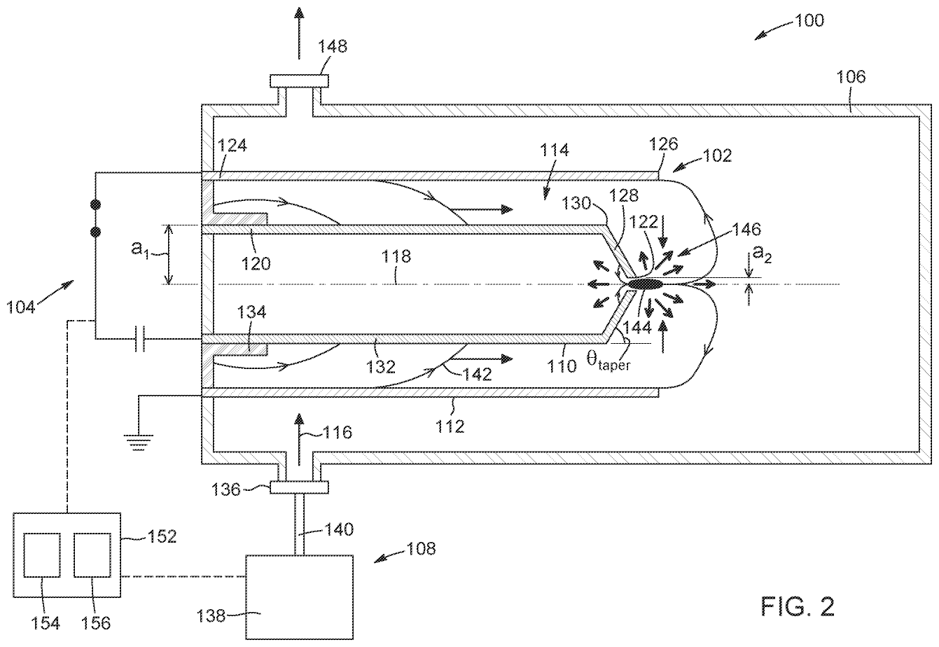

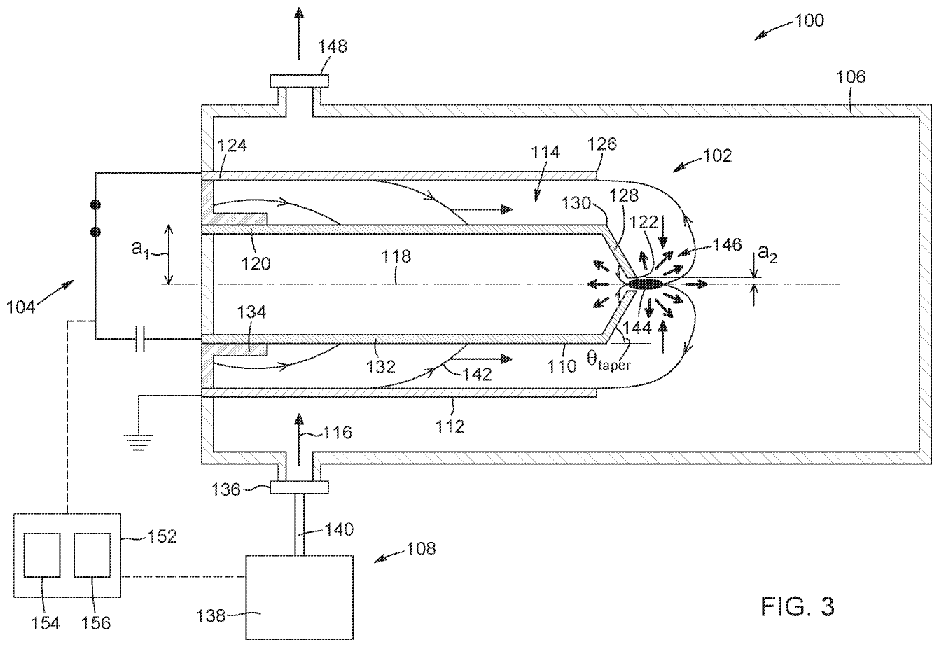

The electrode assembly 102 includes an inner electrode 110 and an outer electrode 112 forming a plasma gun. In FIG. 1, the inner electrode 110 is configured as an anode and the outer electrode 112 is configured as a cathode (i.e., the inner electrode 110 is positively biased with respect to the outer electrode 112), but reversing the polarity of the electrodes 110, 112 is possible in other embodiments. The outer electrode 112 surrounds the inner electrode 110 with an interelectrode radial gap therebetween defining an annular plasma channel 114 configured to receive therein a process gas 116 including aneutronic fusion fuel. Each of the inner electrode 110 and the outer electrode 112 has an elongated configuration along a pinch axis 118. As used herein, the terms “longitudinal” and “axial” refer to a direction parallel to the pinch axis 118, while the terms “radial” and “transverse” refer to a direction that lies in a plane perpendicular to the pinch axis 118. The inner electrode 110 extends longitudinally between a discharge end 120 and a focus end 122, and the outer electrode 112 extends longitudinally between a discharge end 124 and a focus end 126. The inner electrode 110 terminates in a tapered tip 128 at the focus end 122. In some embodiments, the focus end 122 of the inner electrode 110 is longitudinally aligned with the focus end 126 of the outer electrode 112. In other embodiments, the focus end 122 of the inner electrode 110 is disposed longitudinally ahead or behind the focus end 126 of the outer electrode 112, as depicted in FIGS. 2 and 3, respectively.

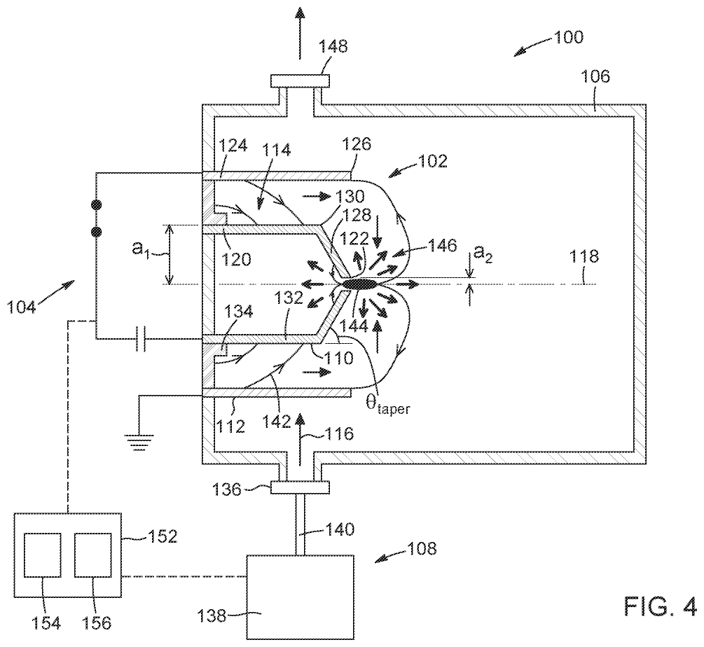

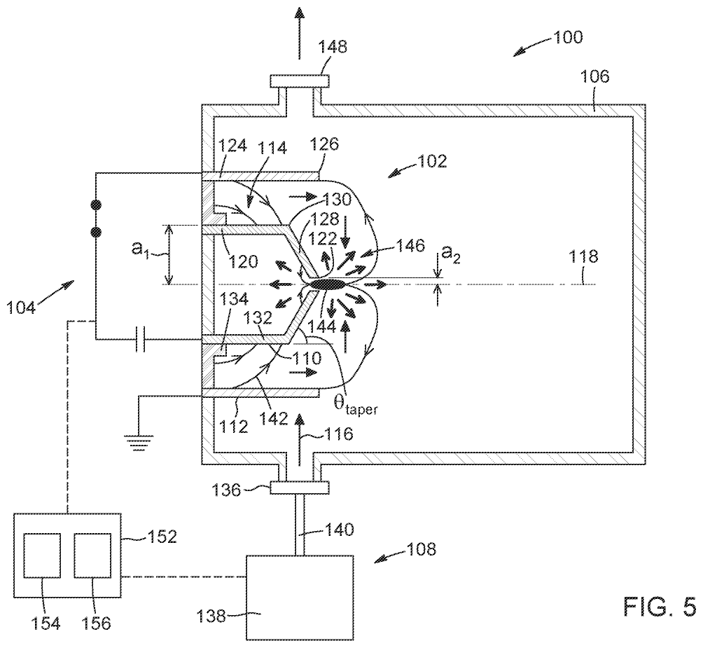

Returning to FIG. 1, in the illustrated arrangement, the inner electrode 110 and the outer electrode 112 both have a substantially cylindrical configuration, with a circular cross-section transverse to the pinch axis 118. The outer electrode 112 encloses the inner electrode 110 in a coaxial arrangement with respect to the pinch axis 118. Other electrode configurations may be used in other embodiments. Non-limiting examples include, to name a few, non-coaxial arrangements and non-circularly symmetric transverse cross-sections. In some embodiments, the inner electrode 110 may have a length ranging from about 4 cm to about 80 cm and a radius ranging from about 2 cm to about 40 cm (in the non-tapered section). In some embodiments, the outer electrode 112 may have a length ranging from about 3 cm to about 100 cm, and a radius ranging from about 3 cm to about 50 cm. Other inner and outer electrode dimensions may be used in other embodiments. Depending on the application, the ratio of the length to the diameter (outside the tapered tip 128) of the inner electrode 110 can be greater than (as depicted in FIG. 1), equal to (as depicted in FIG. 4), or less than one (as depicted in FIG. 5).

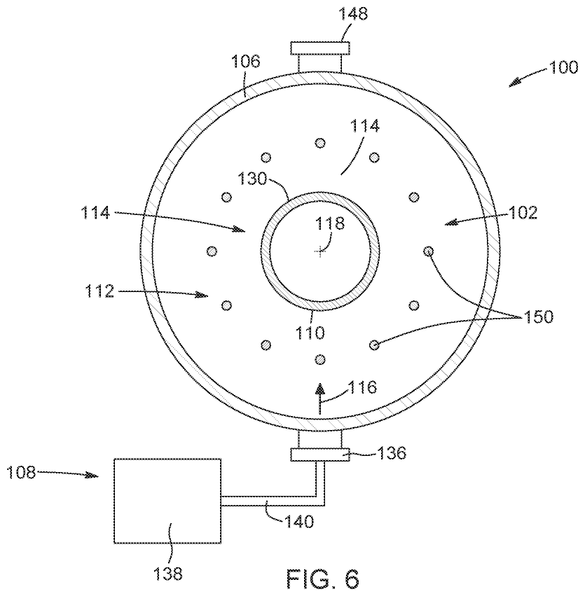

Returning to FIG. 1, the inner electrode 110 and the outer electrode 112 may each be made of any suitable electrically conductive material, such as various metals and metal alloys. Non-limiting examples include, to name a few, copper and brass. In some embodiments, the outer electrode 112 may have a hollow cylindrical body with a continuous circumferential surface. Referring to FIG. 6, in other embodiments, the outer electrode 112 may include a set of rods 150 extending longitudinally along and distributed azimuthally around the pinch axis 118, so that the outer electrode 112 has a discontinuous circumferential surface, with inter-rod gaps formed by the azimuthal spaces between the rods 150.

Returning to FIG. 1, the plasma channel 114 has a substantially annular cross-sectional shape defined by the cross-sectional shapes of the inner electrode 110 and the outer electrode 112. The plasma channel 114 has a closed end, at the discharge ends 120, 124 of the electrodes 110, 112, and an open end, at the focus ends 122, 126 of the electrodes 110, 112. As the plasma channel 114 forms a portion of the interior of the vacuum chamber 106, the plasma channel 114 is configured to receive the process gas 116 from the process gas supply unit 108.

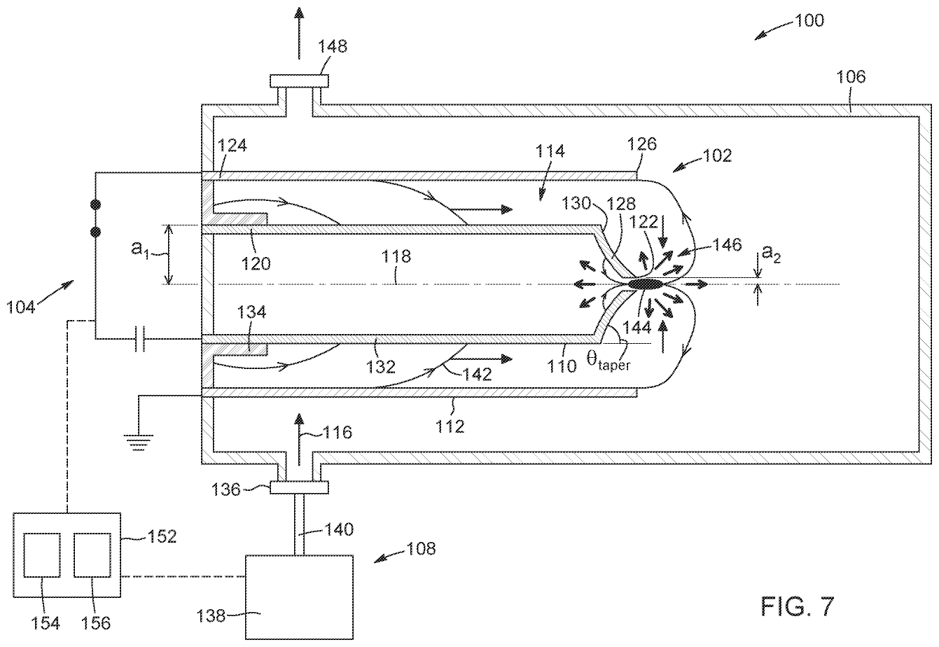

Referring still to FIG. 1, the tapered tip 128 tapers from a first radius a₁, at a taper start point 130 located between the discharge end 120 and the focus end 122, to a second radius a₂, at the focus end 122. The straight section 132 of the inner electrode 110 that extends between the discharge end 120 and the taper start point 130 has a longitudinally constant transverse cross-section of radius a₁. In some embodiments, the radius ratio a₁/a₂ ranges from about twenty to about one hundred. For example, the radius ratio a₁/a₂ may be larger than twenty (e.g., between twenty and one hundred), or larger than thirty (e.g., between thirty and one hundred), or larger than forty (e.g., between forty and one hundred), or larger than fifty (e.g., between fifty and one hundred), or larger than sixty (e.g., between sixty and one hundred), or larger than seventy (e.g., between seventy and one hundred), or larger than eighty (e.g., between eighty and one hundred), or larger than ninety (e.g., between ninety and one hundred). In some embodiments, the first radius a₁ ranges from about 2 cm to about 40 cm, while the second radius a₂ ranges from about 1 mm to about 20 mm. In some embodiments, the tapered tip 128 tapers from the first radius a₁ to the second radius a₂ at a tapering angle θₜₐₚₑᵣ ranging from about 40° to about 85°, with the tapering angle θₜₐₚₑᵣ being defined with respect to a direction parallel to the pinch axis 118, as illustrated in FIG. 1. In some embodiments, the tapered tip 128 tapers linearly from the first radius a₁ to the second radius a₂, as in FIG. 1. In other embodiments, the tapered tip 128 tapers nonlinearly from the first radius a₁ to the second radius a₂, as depicted in FIG. 7. Returning to FIG. 1, in some embodiments, the tapered tip has a longitudinal extent ranging from about 1 cm to about 10 cm. In some embodiments, a ratio of the longitudinal extent of the tapered tip 128 to a longitudinal extent of the inner electrode 110 ranges from about 0.05 to about 0.7. More details are provided below regarding how the provision of the tapered tip 128 can produce aneutronic fusion from the aneutronic fusion fuel contained in the process gas 116.

The electrode assembly 102 of FIG. 1 also includes an electrode insulator 134 disposed between the inner electrode 110 and the outer electrode 112 at the discharge ends 120, 124 thereof. The electrode insulator 134 is configured to provide electrical insulation between the inner electrode 110 and the outer electrode 112. The electrode insulator 134 is also configured to provide a discharge surface on which the ionization and breakdown of the process gas 116 can be initiated. In FIG. 1, the electrode insulator 134 has an annular cross-sectional shape, but other shapes are possible in other embodiments. Depending on the application, the electrode insulator 134 may be formed of one piece or material or multiple pieces of material. The electrode insulator 134 may be made of any suitable electrically insulating material. Non-limiting examples of such possible materials include, to name a few, alumina, ceramics, and quartz. Depending on the application, the electrode insulator 134 may be of varying sizes, shapes, compositions, locations, and configurations.

Referring still to FIG. 1, the power supply unit 104 is electrically connected to the inner electrode 110 and the outer electrode 112 via appropriate electrical connections. The term “power supply” refers herein to any device or combination of devices configured to supply electrical power into a form usable by another device or combination of devices. In some embodiments, the power supply unit 104 can include a pulsed high-power source (e.g., a capacitor bank, a Marx generator, or a linear transformer driver) and a switch (e.g., a spark gap, an ignitron, or a semiconductor switch). Other suitable types of power supplies may be used in other embodiments. The power supply unit 104 is configured to apply a discharge driving signal to the inner electrode 110 and the outer electrodes 112, so as to create a discharge voltage across the plasma channel 114. In some embodiments, the discharge driving signal is a voltage pulse having a peak magnitude ranging from about 12 kV to about 1 MV, a half-cycle pulse duration ranging from about 1 μs to about 50 μs, and a peak current amplitude ranging from about 100 kA to about 10 MA, although other peak magnitude voltage values, other pulse duration values, and other peak current amplitudes may be used in other embodiments. It is appreciated that the instrumentation, implementation, and operation of power supplies used in plasma focus systems are generally known in the art and need not be described in greater detail herein.

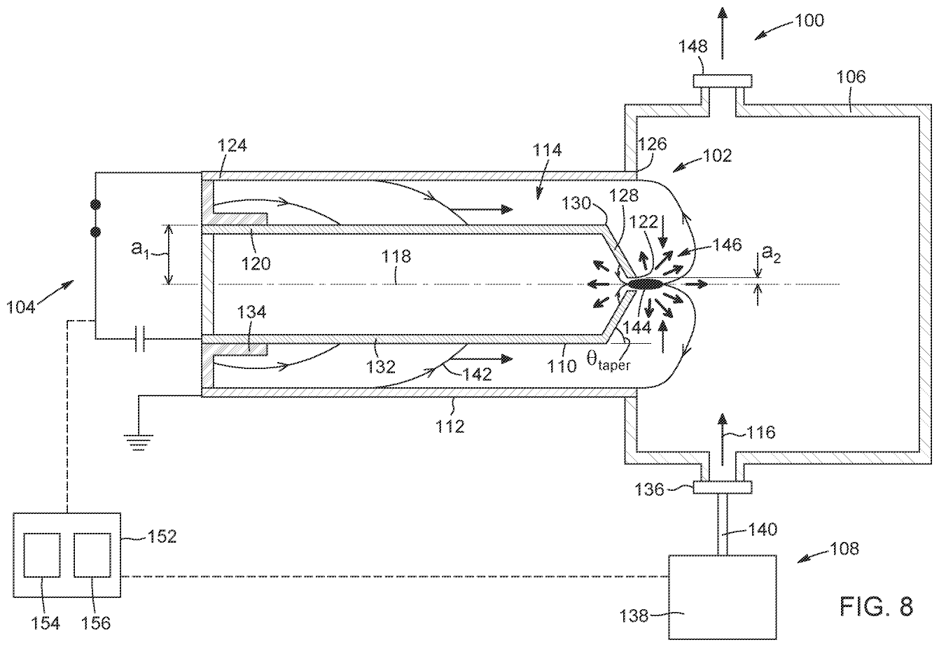

The vacuum chamber 106 is configured to house various components of the plasma focus system 100, including the plasma channel 114 defined in the annular gap formed between the inner electrode 110 and the outer electrode 112. The vacuum chamber 106 may be embodied by any suitable pressure vessel. In some embodiments, the vacuum chamber 106 may be provided as a cylindrical tank made of stainless steel and coaxially enclosing the electrode assembly 102. Various other configurations may be used in other embodiments. For example, in some embodiments, the outer electrode 112 may form part of the vacuum chamber 106, as depicted in the embodiment of FIG. 8. Returning to FIG. 1, the vacuum chamber 106 can include at least one gas inlet port 136 configured for connection to the process gas supply unit 108 to allow the process gas 116 to be introduced inside the vacuum chamber 106. The vacuum chamber 106 can also include various other ports, such as a vacuum pump port 148 and diagnostics ports (not shown). In some embodiments, the vacuum pump port 148 can be connected to a vacuum pump system (not shown) of sufficient capacity to achieve a base pressure lower than 1/100 of the lowest operational pressure when filled with the process gas 116. The vacuum chamber 106 may be connected to a pressure control unit (not shown) configured to control the fill pressure of the process gas 116 inside the vacuum chamber 106. In some embodiments, the fill pressure of the process gas 116 can range from about 1 Torr to about 100 Torr, although other ranges of fill pressure may be used in other embodiments.

The process gas 116 can be any suitable gas or gas mixture containing aneutronic fusion fuel capable of undergoing aneutronic fusion reactions within the plasma focus system 100. Non-limiting examples of aneutronic fusion fuel that can be used as the process gas 116 includes decaborane B₁₀H₁₄ (for the p-¹¹B reaction), deuterium-helium-3 (for the D-³He reaction), helium-3 (for the ³He-³He reaction), lithium hydride (for the p-⁶Li reaction or the p-⁷Li reaction), lithium deuteride (for the D-⁶Li reaction), and any other practical aneutronic fusion fuel or fuel mixtures.

The process gas supply unit 108 can include or be coupled to a gas source 138 configured to store the process gas 116. The gas source 138 can be embodied by a gas storage tank or any suitable pressurized dispensing container. The process gas supply unit 108 can also include a process gas supply line 140 connected between the gas source 138 and the gas inlet port 136 of the vacuum chamber 106 to allow the process gas 116 to enter and fill the interior of the vacuum chamber 106. The process gas supply unit 108 can also include various additional flow control devices (not shown), for example, valves, pumps, regulators, restrictors, pulsed electric discharge systems, and pulsed laser irradiation systems configured to control the introduction or the creation of the process gas 116 inside the vacuum chamber 106. It is appreciated that various configurations and arrangements are contemplated for the process gas supply unit 108, and that various gas injection techniques can be used.

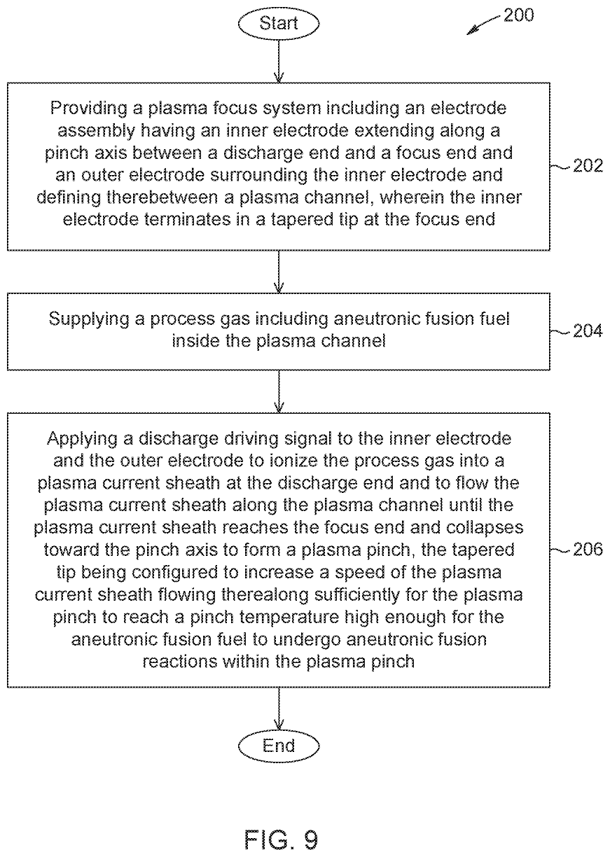

The operation of embodiments of the plasma focus system disclosed herein will now be considered in greater detail, with reference to the flow diagram of FIG. 9, which represents an embodiment of a plasma focus method 200 of aneutronic fusion. It is appreciated that the theory and operation of the various phases of plasma focus dynamics-including the breakdown phase, the axial acceleration phase, the radial compression phase and the pinch phase, as well as their various sub-phases—are generally known in the art and need not be described in detail herein other than to facilitate an understanding of the present techniques (see, e.g., [2, 3]).

The method 200 can include a step 202 of providing a plasma focus system 100, such as the ones depicted in FIG. 1 to 8, or another suitable plasma focus system. The plasma focus system 100 can include an electrode assembly 102 having an inner electrode 110 and an outer electrode 112. The inner electrode 110 extends along a pinch axis 118 between a discharge end 120 and a focus end 122 and terminates in a tapered tip 128 at the focus end 122. The outer electrode 112 surrounds the inner electrode 110 and defines therebetween a plasma channel 114. For example, the outer electrode 112 can enclose the inner electrode 110 in a coaxial arrangement with respect to the pinch axis 118.

The method 200 can also include a step 204 of supplying a process gas 116 containing aneutronic fusion fuel inside the plasma channel 114 formed between the inner electrode 110 and the outer electrode 112. This step 204 can be performed by using a suitable process gas supply unit 108 to supply the process gas 116 into a vacuum chamber 106 housing at least part of the electrode assembly 102. Non-limiting examples of aneutronic fusion fuels have been given above. In some embodiments, the step 204 of supplying the process gas 116 inside the plasma channel 114 can be performed over a time period ranging from about 1 second to about 100 seconds.

The method 200 can further include a step 206 of applying the discharge driving signal to the inner electrode 110 and the outer electrode 112. This step 206 can be performed by using a suitable power supply unit 104 that is part of or coupled to plasma focus system 100. For example, the power supply unit 104 can be embodied by a pulsed-DC power supply including a capacitor bank and a switch. The application of the discharge driving signal causes the process gas 116 to be ionized and to form a plasma current sheath 142 inside the plasma channel 114, at the discharge ends 120, 124 of the electrodes 110, 112. The Lorentz force drives the plasma current sheath 142 down the plasma channel 114. Upon reaching the focus end 122 of the inner electrode 110, the plasma current sheath 142 radially collapses toward the pinch axis 118 to form a hot and dense plasma pinch 144. In some embodiments, the tapered tip 128 has a hollow interior, which can allow the plasma pinch 144 to extend at least partly inside the tapered tip 128.

In some embodiments, the step 206 of applying the discharge driving signal (e.g., by discharging the capacitor bank of the power supply unit 104 into the electrode assembly 102) can be performed over a time period ranging from about 1 microsecond to about 1 millisecond. In some embodiments, the step 206 of applying the discharge driving signal can be initiated after a time delay ranging from about 1 millisecond to about 100 seconds after initiating the step 204 of supplying the process gas 116 inside the plasma channel 114. In some embodiments, the step 206 of applying the discharge driving signal can be repeated at longer intervals (e.g., the discharge driving signal is applied once every one minute to sixty minutes or longer, which can be referred to as a single-shot operation mode) or at shorter intervals (e.g., the discharge driving signal is applied once every ten milliseconds to tens seconds, which can be referred to as a repetitive-shot operation mode). In some embodiments, the processes going from the formation of the plasma current sheath to the generation of the fusion neutrons 146 can occur over a time period ranging from about 1 microsecond to about 10 microseconds.

In the plasma focus system 100 of FIG. 1, the tapered tip 128 of the inner electrode 110 is configured to increase the speed of the plasma current sheath 142 as it flows therealong sufficiently for the resulting plasma pinch 144 to reach a pinch temperature at which thermonuclear aneutronic fusion reactions can occur among the constituent nuclei of the aneutronic fusion fuel, thus releasing fusion product ions 146 other than neutrons. For example, in the case of the p-¹¹B reaction, the fusion product ions 146 are three electrically charged alpha particles, which could potentially allow for direct energy conversion to electricity. In addition, instabilities and turbulences that occur within the plasma pinch 144 can generate beams of charged particles (i.e., electrons and aneutronic fuel ions—e.g., protons and ¹¹B ions in the case of the p-¹¹B reaction), electromagnetic radiation (e.g., X-rays), and further aneutronic fusion reactions (e.g., beam-target aneutronic fusion reactions resulting from accelerated aneutronic fuel ions colliding with aneutronic fuel ions of the bulk plasma). In some embodiments, the tapered tip 128 is configured to increase, during the radial phase, the maximum speed of the plasma current sheath 142 by a speed-enhancement factor ranging from about eight to about fifty compared to the maximum sheath speed achievable without the provision of the tapered tip 128. For example, in some embodiments, the step 206 of applying the discharge driving signal can include controlling the discharge driving signal based on the configuration of the tapered tip 128 to control a speed of the plasma current sheath 142 to reach a maximum sheath speed value ranging from about 100 cm/μs to about 1,000 cm/μs as the plasma current sheath collapses toward the pinch axis to form the plasma pinch 144. Such speed values during the radial phase are significantly higher than those achievable in conventional plasma focus systems, which can range from about 14 cm/μs to about 30 cm/μs. In some embodiments, the processes going from the formation of the plasma current sheath to the generation of the aneutronic fusion product ions 146 can occur over a time period ranging from about 1 microsecond to about 10 microseconds.

In addition to increasing the speed of the plasma current sheath 142 in the radial phase just before formation of the plasma pinch 144, the provision of the tapered tip 128 can allow for the angular disparity due to the mass-field-force-field separation effect mentioned above to be controlled (e.g., avoided or at least mitigated). When the plasma current sheath 142 flows along the tapered tip 128, its speed gradually increases until the plasma current sheath 142 reaches the end of the tapered tip 128, which corresponds to the focus end 122 of the inner electrode 110. Then, the radial phase begins, which leads to the formation of the plasma pinch 144. With the provision of the tapered tip 128, the plasma current sheath 142 can move at a significantly higher speed during the radial phase than in conventional plasma focus systems. This enhanced sheath speed in the radial phase can be understood from the fact that the speed factor of the plasma current sheath 142, at any radius r, is

$$S = ( I / r ) {p}^{- 1 / 2} .$$

This means that the ratio of the sheath speed at the exit of the tapered tip 128 to the sheath speed at the entrance of the tapered tip 128 is expected to scale as a₁/a₂. The step 206 of applying the discharge driving signal can include controlling the discharge driving signal to control a speed of the plasma current sheath 142 prior to the tapered tip to remain below a threshold sheath speed value at which the plasma current sheath 120 undergoes or is expected to undergo mass-field-force-field separation. For example, in some embodiments, the threshold sheath speed value can be about 10 cm/μs.

It is appreciated that by providing a sufficiently large tapering angle (e.g., larger than 40°), the tapered tip 128 can have both a sufficiently large radius ratio a₁/a₂ to achieve aneutronic fusion and a sufficiently short axial length to avoid or at least mitigate the angular disparity between the mass-field direction and the force-field direction due to the mass-field-force-field separation. It is also appreciated that in some embodiments, the plasma focus system 100 can be operated as would a conventional plasma focus system (e.g., operating with axial speeds of the order of 10 cm/μs), so that the increase in speed along the tapered tip 128 results from the provision of the tip 128 itself, without requiring additional changes in the operating parameters of the system 100 (e.g., in the operating parameters of the power supply unit 104 and/or the vacuum chamber 106).

In the plasma focus system 100 of FIG. 1, the plasma pinch 144 that is formed at the focus end 122 of the inner electrode 110 has a starting radial phase radius equal to a₂, which is smaller than the starting radial phase radius a₁ that would be obtained without the tapered tip 128. Thus, the compressing magnetic force acting on the plasma in the radial phase that forms the plasma pinch 144 is greater with the tapered tip 128 than without, resulting in greater implosion speed in the radial phase and in turn higher pinch temperature. As the pinch temperature T_{pinch} scales about quadratically with the speed factor S, the provision of the tapered tip 128 can increase the pinch temperature by a factor T_{pinch,taper}/T_{pinch,no-taper} that scales as (a₁/a₂)²(Iₜₐₚₑᵣ/Iₙₒ₋ₜₐₚₑᵣ)², where Iₜₐₚₑᵣ and Iₙₒ₋ₜₐₚₑᵣ are the peak drive currents with and without the tapered tip 128, respectively. Due to the already angled flow along the length of the tapered tip 128, there is only a small angle to turn into the radial phase so that the angular disparity due to any residual mass-field-force-field separation is reduced. It is noted that Iₜₐₚₑᵣ is generally less than Iₙₒ₋ₜₐₚₑᵣ due to the additional inductive effects of the increased speeds of the plasma current sheath 142 down the length of the tapered tip 128. For example, using a₁/a₂=40 and Iₜₐₚₑᵣ/Iₙₒ₋ₜₐₚₑᵣ=0.9 yields T_{pinch,taper}/T_{pinch,no-taper}≈1300. According to this example, the provision of the tapered tip 128 at the focus end 122 of the inner electrode 110 can increase the pinch temperature from 0.1 keV, which is a pinch temperature observed in large conventional plasma focus systems, to 130 keV, which is a pinch temperature at which several aneutronic fusion reactions become achievable. In some embodiments, the step 206 of applying the discharge driving signal includes controlling the discharge driving signal based on the configuration of the tapered tip 128 to form the plasma pinch 144 with a pinch temperature T_{pinch} ranging from about 30 keV to about 500 keV.

It is appreciated that by adjusting the radius ratio of the tapered tip 128, the pinch temperature can be increased in a controlled manner to suit a particular aneutronic fusion reaction, as different aneutronic fusion reactions involve different temperature conditions. For example, the following aneutronic fusion reactions are characterized by the following ignition temperatures: p-¹¹B reaction: 123 keV; p-⁶Li reaction: 66 keV; and D-³He reaction: 58 keV. Thus, using T_{pinch,no-taper}=0.1 keV and Iₜₐₚₑᵣ/Iₙₒ₋ₜₐₚₑᵣ=0.9 as in the example above yields T_{pinch,taper}=123 keV for a₁/a₂≈39; T_{pinch,taper}=66 keV for a₁/a₂≈29; and T_{pinch,taper}=58 keV for a₁/a₂≈27.

The thermonuclear reactivity <σv> represents the fusion cross-section and relative velocity of two potential fusion reactants, averaged over the Maxwell-Boltzmann distribution. The thermonuclear reactivity <σv> characterizes the probability of a given thermonuclear fusion reaction as a function of the kinetic temperature of the reactants. The thermonuclear reactivities of many aneutronic fusion reactions, including the p-¹¹B, p-⁶Li, and D-³He reactions, increase exponentially with increasing temperature in the range from 0.1 keV to 1,000 keV. For example, the thermonuclear reactivity of the p-¹¹B reaction, <σv>_{p-11B}, increases by about four to five orders of magnitude in the range from 20 keV (where <σV>_{p-11B}/<σv>_{D-T}≈10⁻⁵−10⁻⁴) to 400 keV (where <σv>_{p-11B}≈<σv>_{D-T}). This means that the capability of fulfilling the conditions for achieving a particular aneutronic fusion reaction can be quite sensitive to the value of the radius ratio. It has been recognized herein that because the thermonuclear reactivities <σv> of several aneutronic fusion reactions (including the p-¹¹B, p-⁶Li, and D-³He reactions) increase exponentially with increasing temperatures in the range from 0.1 keV to 1000 keV, which overlaps and extends appreciably beyond the pinch temperature range observed in conventional plasma focus systems, a radius ratio a₁/a₂ of at least about one to two orders of magnitude (e.g., ranging from about 20 to about 100) is desirable or required in some embodiments for the tapered tip to achieve aneutronic fusion conditions.

Simulations were carried out using the Lee model code [3], a widely recognized and verified [2; pp. 510-513] code used for simulating the operation of plasma focus systems. The simulations were performed with several gases with higher atomic numbers Z than any of the possible aneutronic fusion fuel constituent mentioned above (e.g., Z=5 for boron) for the purpose of assessing the pinch temperatures that may be achieved when the plasma is subjected to the increased radiation emission due to the higher-Z effect. It is expected that the higher-Z effect would increase the radiation and lead to a certain reduction in the achievable pinch temperature. Using the Lee model code, the pinch temperature obtained for a radius ratio a₁/a₂=40 was 61 keV for neon (Z=10) and 105 keV with a D-T mixture. Both temperature values are lower than the pinch temperature of about 130 keV obtained from taper ratio scaling relationship introduced above (i.e., T_{pinch,taper}/T_{pinch,no-taper}˜(a₁/a₂)²(Iₜₐₚₑᵣ/Iₙₒ₋ₜₐₚₑᵣ)²). Since an aneutronic plasma would be expected to radiate more than a D-T plasma but less then a neon plasma, one may reasonably expect that the pinch temperature of the aneutronic plasma with a₁/a₂=40 would lie somewhere in the range from 61 keV to 105 keV if radiation emission is accounted for. In fact, considering in more detail the Z-dependence of radiation emission, it is expected that the pinch temperature of the aneutronic plasma would be much closer (i.e., 94 keV) to that of the simulated D-T plasma (i.e., 105 keV) than to that of the simulated neon plasma (i.e., 61 keV). This reduction in pinch temperature due to radiation emission may be accounted for in the taper ratio scaling relationship by introducing a correction factor, C_{radiation}, such that T_{pinch,taper}/T_{pinch,no-taper}˜C_{radiation}(a₁/a₂)²(Iₜₐₚₑᵣ/Iₙₒ₋ₜₐₚₑᵣ)². Using C_{radiation}≈¾ (i.e., from 125 keV/94 keV≈¾), one finds that T_{pinch,taper}=123 keV for a₁/a₂≈45 instead of a₁/a₂≈39; T_{pinch,taper}=66 keV for a₁/a₂≈33 instead of a₁/a₂≈29; and T_{pinch,taper}=58 keV for a₁/a₂≈31 instead of a₁/a₂≈27. It is appreciated that the impact of radiation emission on reducing pinch temperature could be accounted for with only a modest increase (i.e., of the order of C_{radiation}^{1/2}) in the value of the radius ratio a₁/a₂. It is also appreciated that different values of C_{radiation} can be used in other embodiments depending, for example, on the operation conditions and the type of aneutronic fusion fuel, and that different or more complex functions may be used for modeling C_{radiation} in certain cases.

Referring to FIG. 1, on some embodiments, the plasma focus system 100 can include a direct energy conversion unit 158 configured to extract energy from the aneutronic fusion reaction product ions 146 and to convert the extracted energy to electricity. For example, the direct energy conversion unit can be embodied by a magnetohydrodynamic generator including electromagnets producing a magnetic field transverse to the pinch axis 118. The expansion of the hot fusion plasma together with the charged particles of the fusion products can cause an electric potential difference which can be extracted using pairs of electrodes. See, e.g., [4]. For example, in some embodiments, the direct energy conversion unit 158 can include extraction antenna coils wrapped around the plasma pinch 144 along its length.

Referring still to FIG. 1, the plasma focus system 100 can further include a control and processing unit 152 configured to control, monitor, and/or coordinate the functions and operations of various system components, including the power supply unit 104, the vacuum chamber 106, and the process gas supply unit 108, as well as various temperature, pressure, flow rate, and power conditions. In particular, the control and processing unit 152 may be configured to synchronize or otherwise time-coordinate the functions and operations of various components of the plasma focus system 100. The control and processing unit 152 can be implemented in hardware, software, firmware, or any combination thereof, and be connected to various components of the plasma focus system 100 via wired and/or wireless communication links to send and/or receive various types of signals, such as timing and control signals, measurement signals, and data signals. The control and processing unit 152 may be controlled by direct user input and/or by programmed instructions, and may include an operating system for controlling and managing various functions of the plasma focus system 100. Depending on the application, the control and processing unit 152 may be fully or partly integrated with, or physically separate from, the other hardware components of the plasma focus system 100. The control and processing unit 152 can include a processor 154 and a memory 156.

The processor 154 can implement operating systems, and may be able to execute computer programs, also known as commands, instructions, functions, processes, software codes, executables, applications, and the like. While the processor 154 is depicted in FIG. 1 as a single entity for illustrative purposes, the term “processor” should not be construed as being limited to a single processing entity, and accordingly, any known processor architecture may be used. In some embodiments, the processor 154 may include a plurality of processing entities. Such processing entities may be physically located within the same device, or the processor 154 may represent the processing functionalities of a plurality of devices operating in coordination. For example, the processor 154 may include or be part of one or more of a computer; a microprocessor; a microcontroller; a coprocessor: a central processing unit (CPU); a special-purpose programmable logic device embodied in hardware device, such as, for example, a field-programmable gate array (FPGA) or an application-specific integrated circuit (ASIC); a digital processor; an analog processor; and/or other mechanisms configured to electronically process information and to operate collectively as a processor.

The memory 156, which may also be referred to as a “computer readable storage medium” or a “computer readable memory” is configured to store computer programs and other data to be retrieved by the processor 154. The terms “computer readable storage medium” and “computer readable memory” refer herein to a non-transitory and tangible computer product that can store and communicate executable instructions for the implementation of various steps of the techniques disclosed herein. The memory 156 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 156 may be associated with, coupled to, or included in the processor 154, and the processor 154 may be configured to execute instructions contained in a computer program stored in the memory 156 and relating to various functions and operations associated with the processor 154. While the memory 156 is depicted in FIG. 1 as a single entity for illustrative purposes, the term “memory” should not be construed as being limited to a single memory unit, and accordingly, any known memory architecture may be used. In some embodiments, the memory 156 may include a plurality of memory units. Such memory units may be physically located within the same device, or the memory 156 can represent the functionalities of a plurality of devices operating in coordination.

The plasma focus system 100 may also include one or more user interface devices (not shown) operatively connected to the control and processing unit 152 to allow the input of commands and queries to the plasma focus system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The following aspects are also disclosed herein.
1. A plasma focus system for aneutronic fusion, comprising:
   an electrode assembly comprising:
      an inner electrode extending along a pinch axis between a discharge end and a focus end, the inner electrode terminating in a tapered tip at the focus end; and
      an outer electrode surrounding the inner electrode and defining therebetween a plasma channel configured to receive a process gas comprising aneutronic fusion fuel; and
   a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch, and wherein the tapered tip is configured to increase a speed of the plasma current sheath flowing therealong sufficiently for the plasma pinch to reach a pinch temperature at which the aneutronic fusion fuel undergoes aneutronic fusion reactions within the plasma pinch.
2. The plasma focus system of aspect 1, wherein the tapered tip tapers from a first radius, at a taper start point located between the discharge end and the focus end, to a second radius, at the focus end, wherein a ratio of the first radius to the second radius ranges from about twenty to about one hundred.
3. The plasma focus system of aspect 2, wherein the first radius ranges from about 2 cm to about 40 cm and the second radius ranges from about 1 mm to about 20 mm.
4. The plasma focus system of aspect 2 or 3, wherein the tapered tip tapers from the first radius to the second radius at a tapering angle ranging from about 400 to about 85°, wherein the tapering angle is defined with respect to a direction parallel to the pinch axis.
5. The plasma focus system of any one of aspects 2 to 4, wherein the tapered tip tapers linearly from the first radius to the second radius.
6. The plasma focus system of any one of aspects 2 to 4, wherein the tapered tip tapers nonlinearly from the first radius to the second radius.
7. The plasma focus system of any one of aspects 1 to 6, wherein the tapered tip has a longitudinal extent ranging from about 1 cm to about 10 cm.
8. The plasma focus system of aspect 7, wherein a ratio of the longitudinal extent of the tapered tip to a longitudinal extent of the inner electrode ranges from about 0.05 to about 0.7.
9. The plasma focus system of any one of aspects 1 to 8, wherein a ratio of a longitudinal extent of the inner electrode to a diameter of the inner electrode at the discharge end is greater than one.
10. The plasma focus system of any one of aspects 1 to 8, wherein a ratio of a longitudinal extent of the inner electrode to a diameter of the inner electrode at the discharge end is equal to or less than one.
11. The plasma focus system of any one of aspects 1 to 10, wherein the tapered tip has a hollow interior configured to allow the plasma pinch to extend at least partially thereinside.
12. The plasma focus system of any one of aspects 1 to 11, wherein the power supply unit comprises a pulsed-DC power supply comprising a capacitor bank and a switch.
13. The plasma focus system of any one of aspects 1 to 12, wherein the power supply unit is configured to apply the discharge driving signal as a voltage pulse having a peak magnitude ranging from about 12 kV to about 1 MV, a half-cycle pulse duration ranging from about 1 μs to about 50 s, and a peak current amplitude ranging from about 100 kA to about 10 MA.
14. The plasma focus system of any one of aspects 1 to 13, wherein the power supply unit is configured to apply the discharge driving signal based on the configuration of the tapered tip to control a speed of the plasma current sheath to reach a maximum sheath speed value ranging from about 100 cm/μs to about 1,000 cm/μs as the plasma current sheath collapses toward the pinch axis to form the plasma pinch.
15. The plasma focus system of any one of aspects 1 to 14, wherein the power supply unit is configured to apply the discharge driving signal based on the configuration of the tapered tip to form the plasma pinch with a pinch temperature ranging from about 30 keV to about 500 keV.
16. The plasma focus system of any one of aspects 1 to 15, wherein the power supply unit is configured to apply the discharge driving signal to control a maximum speed of the plasma current sheath prior to the tapered tip to remain below a threshold sheath speed value at which the plasma current sheath undergoes mass-field-force-field separation.
17. The plasma focus system of aspect 16, wherein the threshold sheath speed value is about 10 cm/μs.
18. The plasma focus system of any one of aspects 1 to 17, wherein the electrode assembly comprises an electrical insulator interposed between the inner electrode and the outer electrode at the discharge end.
19. The plasma focus system of any one of aspects 1 to 18, further comprising a vacuum chamber housing at least part of the electrode assembly and configured to contain the process gas therein.
20. The plasma focus system of aspect 19, wherein the outer electrode forms part of the vacuum chamber.
21. The plasma focus system of any one of aspects 1 to 20, further comprising a process gas supply unit configured to supply the process gas inside the plasma channel.
22. The plasma focus system of any one of aspects 1 to 21, wherein the aneutronic fusion fuel comprises decaborane B₁₀H₄, for the p-¹¹B reaction; or deuterium-helium-3, for the D-³He reaction; or helium-3, for the ³He-³He reaction; or lithium hydride, for the p-⁶Li reaction or the p-⁷Li reaction; or lithium deuteride for the D-⁶Li reaction; or any combination thereof.
23. The plasma focus system of any one of aspects 1 to 22, further comprising a direct energy conversion unit configured to extract energy from reaction products of the aneutronic fusion reactions and convert the extracted energy into electricity.
24. A plasma focus method of aneutronic fusion, comprising:
   providing a plasma focus system comprising an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
   supplying a process gas comprising aneutronic fusion fuel inside the plasma channel; and
   applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch,
   wherein the tapered tip is configured to increase a speed of the plasma current sheath flowing therealong sufficiently for the plasma pinch to reach a pinch temperature high enough for the aneutronic fusion fuel to undergo aneutronic fusion reactions within the plasma pinch.
25. The plasma focus method of aspect 24, wherein providing the plasma focus system comprises configuring the tapered tip to taper from a first radius, at a taper start point located between the discharge end and the focus end, to a second radius, at the focus end, wherein a ratio of the first radius to the second radius ranges from about twenty to about one hundred.
26. The plasma focus method of aspect 25, wherein the first radius ranges from about 2 cm to about 40 cm and the second radius ranges from about 1 mm to about 20 mm.
27. The plasma focus method of aspect 25 or 26, wherein configuring the tapered tip comprises providing the tapered tip with a tapering angle ranging from about 40° to about 85°, wherein the tapering angle is defined with respect to a direction parallel to the pinch axis.
28. The plasma focus method of any one of aspects 24 to 27, wherein configuring the tapered tip comprises providing the tapered tip with a longitudinal extent ranging from about 1 cm to about 10 cm.
29. The plasma focus method of any one of aspects 24 to 28, wherein applying the discharge driving signal comprises applying the discharge driving signal as a voltage pulse having a peak magnitude ranging from about 12 kV to about 1 MV, a half-cycle pulse duration ranging from about 1 μs to about 50 s, and a peak current amplitude ranging from about 100 kA to about 10 MA.
30. The plasma focus method of any one of aspects 24 to 29, wherein applying the discharge driving signal comprises applying the discharge driving signal once every one minute to sixty minutes, corresponding to a single-shot operation mode.
31. The plasma focus method of any one of aspects 24 to 29, wherein applying the discharge driving signal comprises applying the discharge driving signal once every ten milliseconds to ten seconds, corresponding to a repetitive-shot operation mode.
32. The plasma focus method of any one of aspects 24 to 31, wherein applying the discharge driving signal comprises controlling the discharge driving signal based on the configuration of the tapered tip to control a speed of the plasma current sheath to reach a maximum sheath speed value ranging from about 100 cm/μs to about 1,000 cm/μs as the plasma current sheath collapses toward the pinch axis to form the plasma pinch.
33. The plasma focus method of any one of aspects 24 to 32, wherein applying the discharge driving signal comprises controlling the discharge driving signal based on the configuration of the tapered tip to form the plasma pinch with a pinch temperature ranging from about 30 keV to about 500 keV.
34. The plasma focus method of any one of aspects 24 to 33, wherein applying the discharge driving signal comprises controlling the discharge driving signal to control a speed of the plasma current sheath prior to the tapered tip to remain below a threshold sheath speed value at which the plasma current sheath undergoes mass-field-force-field separation.
35. The plasma focus method of aspect 34, wherein the threshold sheath speed value is about 10 cm/μs.
36. The plasma focus method of any one of aspects 24 to 35, wherein providing the plasma focus system comprises enclosing at least part of the electrode assembly in a vacuum chamber configured to contain the process gas therein.
37. The plasma focus method of any one of aspects 24 to 36, wherein the aneutronic fusion fuel comprises decaborane B₁₀H₄, for the p-¹¹B reaction; or deuterium-helium-3, for the D-³He reaction; or helium-3, for the ³He-³He reaction; or lithium hydride, for the p-⁶Li reaction or the p-⁷Li reaction; or lithium deuteride for the D-⁶Li reaction; or any combination thereof.
38. The plasma focus method of any one of aspects 24 to 37, further comprising:
   extracting energy from reaction products of the aneutronic fusion reactions; and
   converting the extracted energy into electricity.

Numerous modifications could be made to the embodiments described above without departing from the scope of the appended claims.

### REFERENCES

The following is a list of references, the entire contents of which are incorporated herein by reference.
1. S. Lee and A. Serban, “Dimensions and lifetime of the plasma focus pinch,” IEEE Transactions on Plasma Science, vol. 24, no. 3, pp. 1101-1105 (1996).
2. S. Auluck, et al. “Update on the Scientific Status of the Plasma Focus,” Plasma, vol. 4, no. 3, pp. 450-669 (2021).
3. S. Lee, “Description of Radiative Dense Plasma Focus Computation Package RADPFV5.16 and Downloads—Lee model code”: http://www.plasmafocus.net/IPFS/modelpackage/File1RADPF.htm
4. G. W. Sutton and A. Sherman, “Engineering Magnetohydrodynamics” (July 2006). Dover Civil and Mechanical Engineering. Dover Publications. ISBN 978-0486450322.

1. A plasma focus system for aneutronic fusion, comprising:
an electrode assembly comprising:
an inner electrode extending along a pinch axis between a discharge end and a focus end, the inner electrode terminating in a tapered tip at the focus end; and
an outer electrode surrounding the inner electrode and defining therebetween a plasma channel configured to receive a process gas comprising aneutronic fusion fuel; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch, and wherein the tapered tip is configured to increase a speed of the plasma current sheath flowing therealong sufficiently for the plasma pinch to reach a pinch temperature at which the aneutronic fusion fuel undergoes aneutronic fusion reactions within the plasma pinch.

2. The plasma focus system of claim 1, wherein the tapered tip tapers from a first radius, at a taper start point located between the discharge end and the focus end, to a second radius, at the focus end, wherein a ratio of the first radius to the second radius ranges from about twenty to about one hundred.

3. The plasma focus system of claim 2, wherein the first radius ranges from about 2 cm to about 40 cm and the second radius ranges from about 1 mm to about 20 mm.

4. The plasma focus system of claim 2, wherein the tapered tip tapers from the first radius to the second radius at a tapering angle ranging from about 40° to about 85°, wherein the tapering angle is defined with respect to a direction parallel to the pinch axis.

5. The plasma focus system of claim 2, wherein the tapered tip tapers linearly from the first radius to the second radius.

6. The plasma focus system of claim 2, wherein the tapered tip tapers nonlinearly from the first radius to the second radius.

7. The plasma focus system of claim 1, wherein the tapered tip has a longitudinal extent ranging from about 1 cm to about 10 cm.

8. The plasma focus system of claim 7, wherein a ratio of the longitudinal extent of the tapered tip to a longitudinal extent of the inner electrode ranges from about 0.05 to about 0.7.

9. The plasma focus system of claim 1, wherein a ratio of a longitudinal extent of the inner electrode to a diameter of the inner electrode at the discharge end is greater than one.

10. The plasma focus system of claim 1, wherein a ratio of a longitudinal extent of the inner electrode to a diameter of the inner electrode at the discharge end is equal to or less than one.

11. The plasma focus system of claim 1, wherein the tapered tip has a hollow interior configured to allow the plasma pinch to extend at least partially thereinside.

12. The plasma focus system of claim 1, wherein the power supply unit comprises a pulsed-DC power supply comprising a capacitor bank and a switch.

13. The plasma focus system of claim 1, wherein the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

14. The plasma focus system of claim 1, wherein the power supply unit is configured to apply the discharge driving signal based on the configuration of the tapered tip to control a speed of the plasma current sheath to reach a maximum sheath speed value ranging from about 100 cm/μs to about 1,000 cm/μs as the plasma current sheath collapses toward the pinch axis to form the plasma pinch.

15. The plasma focus system of claim 1, wherein the power supply unit is configured to apply the discharge driving signal based on the configuration of the tapered tip to form the plasma pinch with a pinch temperature ranging from about 30 keV to about 500 keV.

16. The plasma focus system of claim 1, wherein the power supply unit is configured to apply the discharge driving signal to control a maximum speed of the plasma current sheath prior to the tapered tip to remain below a threshold sheath speed value at which the plasma current sheath undergoes mass-field-force-field separation.

17. The plasma focus system of claim 16, wherein the threshold sheath speed value is about 10 cm/μs.

18. The plasma focus system of claim 1, wherein the electrode assembly comprises an electrical insulator interposed between the inner electrode and the outer electrode at the discharge end.

19. The plasma focus system of claim 1, further comprising a vacuum chamber housing at least part of the electrode assembly and configured to contain the process gas therein.

20. The plasma focus system of claim 19, wherein the outer electrode forms part of the vacuum chamber.

21. The plasma focus system of claim 1, further comprising a process gas supply unit configured to supply the process gas inside the plasma channel.

22. The plasma focus system of claim 1, wherein the aneutronic fusion fuel comprises decaborane B₁₀H₄, for the p-¹¹B reaction; or deuterium-helium-3, for the D-³He reaction; or helium-3, for the ³He-³He reaction; or lithium hydride, for the p-⁶Li reaction or the p-⁷Li reaction; or lithium deuteride for the D-⁶Li reaction; or any combination thereof.

23. The plasma focus system of claim 1, further comprising a direct energy conversion unit configured to extract energy from reaction products of the aneutronic fusion reactions and convert the extracted energy into electricity.

24. A plasma focus method of aneutronic fusion, comprising:
providing a plasma focus system comprising an electrode assembly having an inner electrode extending along a pinch axis between a discharge end and a focus end and an outer electrode surrounding the inner electrode and defining therebetween a plasma channel, wherein the inner electrode terminates in a tapered tip at the focus end;
supplying a process gas comprising aneutronic fusion fuel inside the plasma channel; and
applying a discharge driving signal to the inner electrode and the outer electrode to ionize the process gas into a plasma current sheath at the discharge end and to flow the plasma current sheath along the plasma channel until the plasma current sheath reaches the focus end and collapses toward the pinch axis to form a plasma pinch,
wherein the tapered tip is configured to increase a speed of the plasma current sheath flowing therealong sufficiently for the plasma pinch to reach a pinch temperature high enough for the aneutronic fusion fuel to undergo aneutronic fusion reactions within the plasma pinch.

25. The plasma focus method of claim 24, wherein providing the plasma focus system comprises configuring the tapered tip to taper from a first radius, at a taper start point located between the discharge end and the focus end, to a second radius, at the focus end, wherein a ratio of the first radius to the second radius ranges from about twenty to about one hundred.

26. The plasma focus method of claim 25, wherein the first radius ranges from about 2 cm to about 40 cm and the second radius ranges from about 1 mm to about 20 mm.

27. The plasma focus method of claim 25, wherein configuring the tapered tip comprises providing the tapered tip with a tapering angle ranging from about 40° to about 85°, wherein the tapering angle is defined with respect to a direction parallel to the pinch axis.

28. The plasma focus method of claim 24, wherein configuring the tapered tip comprises providing the tapered tip with a longitudinal extent ranging from about 1 cm to about 10 cm.

29. The plasma focus method of claim 24, wherein applying the discharge driving signal comprises applying the discharge driving signal as a voltage pulse having a peak magnitude ranging from about 12 kV to about 1 MV, a half-cycle pulse duration ranging from about 1 μs to about 50 s, and a peak current amplitude ranging from about 100 kA to about 10 MA.

30. The plasma focus method of claim 24, wherein applying the discharge driving signal comprises applying the discharge driving signal once every one minute to sixty minutes, corresponding to a single-shot operation mode.

31. The plasma focus method of claim 24, wherein applying the discharge driving signal comprises applying the discharge driving signal once every ten milliseconds to ten seconds, corresponding to a repetitive-shot operation mode.

32. The plasma focus method of claim 24, wherein applying the discharge driving signal comprises controlling the discharge driving signal based on the configuration of the tapered tip to control a speed of the plasma current sheath to reach a maximum sheath speed value ranging from about 100 cm/μs to about 1,000 cm/μs as the plasma current sheath collapses toward the pinch axis to form the plasma pinch.

33. The plasma focus method of claim 24, wherein applying the discharge driving signal comprises controlling the discharge driving signal based on the configuration of the tapered tip to form the plasma pinch with a pinch temperature ranging from about 30 keV to about 500 keV.

34. The plasma focus method of claim 24, wherein applying the discharge driving signal comprises controlling the discharge driving signal to control a speed of the plasma current sheath prior to the tapered tip to remain below a threshold sheath speed value at which the plasma current sheath undergoes mass-field-force-field separation.

35. The plasma focus method of claim 34, wherein the threshold sheath speed value is about 10 cm/μs.

36. The plasma focus method of claim 24, wherein providing the plasma focus system comprises enclosing at least part of the electrode assembly in a vacuum chamber configured to contain the process gas therein.

37. The plasma focus method of claim 24, wherein the aneutronic fusion fuel comprises decaborane B₁₀H₄, for the p-¹¹B reaction; or deuterium-helium-3, for the D-³He reaction; or helium-3, for the ³He-³He reaction; or lithium hydride, for the p-⁶Li reaction or the p-⁷Li reaction; or lithium deuteride for the D-⁶Li reaction; or any combination thereof.

38. The plasma focus method of claim 24, further comprising:
extracting energy from reaction products of the aneutronic fusion reactions; and
converting the extracted energy into electricity.
